(19) United States
(12) Patent Application Publication
(10) Pub. No.: US 2015/0278718 A1
(43) Pub. Date: Oct. 1, 2015

(54) SYSTEMS AND METHODS FOR COMMUNICATION SHARING IN A RELATIONSHIP MANAGEMENT SYSTEM

(71) Applicant: salesforce.com, inc., San Francisco, CA (US)

(72) Inventors: Adam Evans, Redwood City, CA (US); Scott Bessler, Mt. View, CA (US); Gary Lerhaupt, San Francisco, CA (US)

(21) Appl. No.: 14/226,987

(22) Filed: Mar. 27, 2014

(51) Int. Cl. G06Q 10/06; G06Q 10/10; G06Q 30/00; G06F 7/36

(52) U.S. Cl. CPC G06Q 10/063; G06F 7/36; G06Q 10/10; G06Q 10/107; G06Q 30/016

(57) ABSTRACT

A method and apparatus for communication sharing in a relationship management system is described. The method may include obtaining an electronic communication by a relationship management system and extracting identification data from the electronic communication. Furthermore, the method may include locating a collaborator and a relationship in the extracted identification data, wherein the collaborator and the relationship are participants in a relationship management process. The method may also include determining when the collaborator and the relationship are both members in a communications sharing list that is associated with the relationship management process, and distributing data associated with the electronic communication to collaborator members in the communications sharing list.

### TECHNICAL FIELD

Embodiments of the invention relate to the field of electronic communication management, and more particularly, to collaborating in a relationship management system.

### BACKGROUND

Customer relationship management (CRM) systems provide tools for managing interactions with customers. The interactions may include the exchange of electronic communications between a user and a customer, such as the exchange of telephone calls, emails, in-person meetings, teleconferences, as well as other types of interactions. CRM solutions collect a centralized record of these interactions. From the record of the interactions, CRM systems attempt to summarize and track the interactions in a meaningful way.

The interactions may also include the interactions of multiple users, such as multiple employees from a company, office, school, etc., with a customer. Furthermore, these interactions may be directed at furthering a common goal. For example, a group of employees in a company may be involved in the sale of a product to a customer. Therefore, it becomes critical that users, such as the group of employees, are aware of the various interactions of the other users with the customer.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram illustrating an exemplary system for automatic and intelligent relationship management in accordance with an embodiment of the invention.

FIG. 2A is a block diagram of an exemplary system architecture for providing a relationship management system in accordance with an embodiment of the invention.

FIG. 2B is a block diagram of one embodiment of a relationship management server and a relationship management application.

FIG. 3 is a flow diagram of one embodiment of a method for communication sharing in a relationship management system.

FIG. 4 is a flow diagram of one embodiment of a method for processing electronic communications for communication sharing in a relationship management system.

FIG. 5 is a flow diagram of one embodiment of a method for utilizing privacy settings for communication sharing in a relationship management system.

FIG. 6 is a flow diagram of one embodiment of a method for altering the privacy settings for an electronic communication.

FIG. 7 is a flow diagram of one embodiment of a method for accessing additional information in electronic communications.

FIG. 8 is one embodiment of a computer system that may be used in accordance with an embodiment of the invention.

### DETAILED DESCRIPTION

In the following description, numerous details are set forth. It will be apparent, however, to one of ordinary skill in the art having the benefit of this disclosure, that the present invention may be practiced without these specific details. In some instances, well-known structures and devices are shown in block diagram form, rather than in detail, in order to avoid obscuring the present invention.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “obtaining”, “extracting”, “locating”, “distributing”, “determining”, “notifying”, “collecting”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

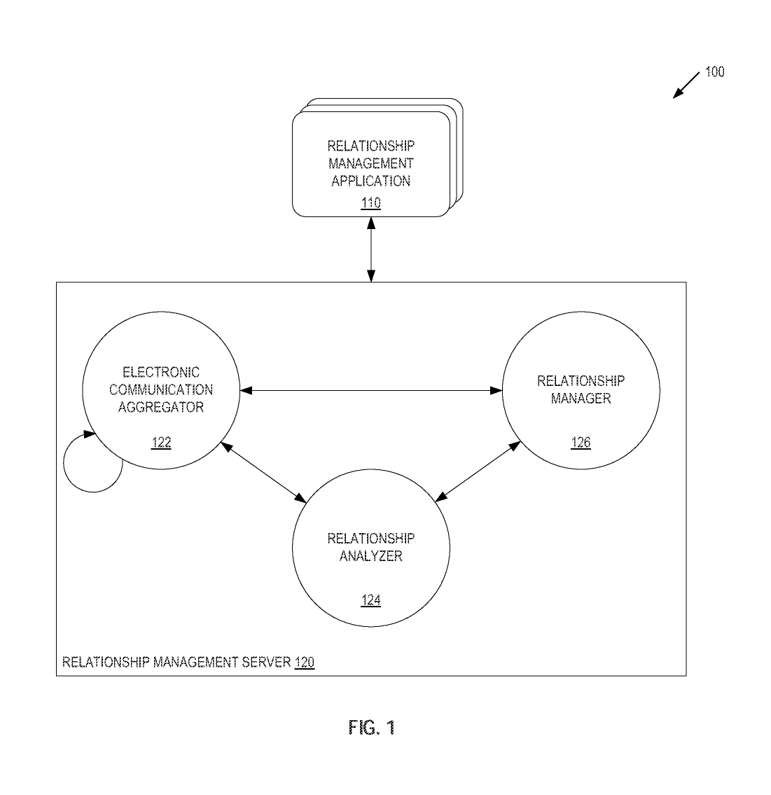

FIG. 1 is a block diagram illustrating an exemplary system 100 for automatic and intelligent relationship management. In embodiments discussed herein, relationship management involves the capture, analysis, and reporting of communications between a single user, or multiple users, within an organization, and various contacts outside of the organization. When a user engages in communication, in concert with a group of users, from an organization, those users are said to be collaborators. Furthermore, when the user and/or collaborators engage in communication with contacts outside the organization for a specific purpose (e.g., sales, business, recruiting, funding, etc.), a relationship is formed. These communications, between relationships and collaborators, may be part of a series of sequential communication and action stages of a process, such as stages of a sales process (e.g., first contact, product demo, price quote, offer, close), a business development process (e.g., growth identification, partner identification, project assignment, growth tracking), a recruiting process (e.g., candidate contact, resume obtained, initial interview, follow-up interview, offer or decline), as well as other processes which are, or can, be carried out with electronic communications. These communications, once identified as belonging to one or more processes, may then be viewed by users and collaborators involved in the particular process based on one or more communication sharing privacy options, as discussed in greater detail below. Additional information, such as details associated with a process, user notes, or other user generated content can also be logged and identified as belong to a process by a user, and thereafter be viewed along with the process communications subject to the one or more communication sharing privacy options. Furthermore, reports may be generated which summarize, provide different visualizations, show progression within a process, and provide feedback on the progression within a process.

In one embodiment, the system 100 for automatic and intelligent relationship management automatically performs various relationship management tasks, such as obtaining electronic communications, tracking those communications within a process, suggesting follow-ups to users and collaborators in response to communications from a process, suggesting team members to add as new collaborators to a process, etc. Furthermore, in one embodiment, the system 100 intelligently interprets the relationship management data, automatically culls contact information from the communications on a periodic or ongoing basis, deduplicates contact information, merges contact information obtained from different sources, combines relationship analysis results obtained from different communication channels, and users, generates process suggestions, follow-up suggestions, and team member collaboration suggestions, as well as performing other types of intelligent data analysis as discussed herein.

In one embodiment, users interact with the relationship management server 120 through a relationship management application 110. In one embodiment, relationship management application 110 is an application executed on a general purpose computing system, such as a desktop computer, a laptop computer, server computer, as well as other computing system. In one embodiment, the relationship management application 110 may also be executed on a mobile device, such as a smartphone, tablet, palmtop, as well as other mobile computing devices.

In one embodiment, relationship management application 110 initially receives a user request to register with relationship management server 120. Relationship management application 110 receives user registration data and indication of one or more digital identities associated with the user. The digital identities may include email addresses, social networking identities, telephone numbers, and other electronic communication identities, and their associated authentication credentials.

In one embodiment, relationship management server 120 receives the user registration data, specification of one or more digital identities, and corresponding authentication credentials, and then automatically and intelligently generates a relationship management system for the user. The resulting relationship management system may be rapidly and newly created for a user, or created by another user to which the registering user is to be added as a team member/collaborator within a process.

In one embodiment, electronic communication aggregator 122 of relationship management server 120 utilizes the received user digital identities, and associated authentication credentials, to cull and ingest electronic communications from the various sources identified by the registering user. In one embodiment, electronic communication aggregator 122 accesses the electronic communication systems to obtain past electronic communications between the user and potential relationship management contacts. For example, electronic communication aggregator 122 utilizes an email address and password to access existing email messages on one or more email provider systems (not shown), such as the GMAIL™, EXCHANGE™, etc., to access existing electronic communications on social network system (not shown), such as FACEBOOK™, TWITTER™, LINKEDIN™, etc., to access voice over internet protocol (VOIP) system communication records, to access cellular telephone system records, to access video conferencing system records, as well as other existing electronic communications and/or records at the specified electronic messaging systems.

From the obtained electronic communications, relationship analyzer 124 automatically identifies contacts associated with the user. In one embodiment, contact data can be identified from recipient data in outgoing email messages, social networking posts, VOIP calls, etc., sender data in incoming email messages, social networking posts, VOIP calls, etc. In one embodiment, the contact data may also be identified within the context of the electronic communication, such as within the text of a message, from specific portions of the text, such as an electronic communication signature extracted from the text, etc. In one embodiment, various pre-learned machine learning models, such as one or more natural language analysis, decision tree, neural network, support vector machines, conditional random fields, unsupervised learning (e.g. clustering), etc. techniques can be deployed by the relationship analyzer 124 to identify contacts, and data associated with the contact from, for example, the signature within the text of a communication, metadata embedded in the communication, communication header data fields, communication addressing, etc.

In the embodiments discussed herein, relationship analyzer 124 interacts with relationship manager 126 to store a record of the automatically extracted contact information and associate the contract information with the communication from which it was extracted. In one embodiment, relationship analyzer 124 may additionally analyze the electronic communications obtained by electronic communications aggregator 122 to automatically determine when to share communications among a group of collaborators. As will be discussed in greater detail below, an initial collaborator may enumerate an interest group, such as a subset of collaborators and relationships that are members of a process, into a communication sharing list. In one embodiment, when communications are exchanged between collaborators and relationships in a process, and the collaborators and relationships are determined to be within a communication sharing list, relationship analyzer 124 shares the communication, or data associated with the communication, with the collaborator list members. In one embodiment, the amount and type of data from the communication that is shared with collaborators in a communication sharing list can be based on various privacy option settings. By sharing communication content, communication occurrence, nature of the communication, etc. the relationship management system provides for a greater degree of collaboration among process collaborators. Furthermore, the process collaborators are provided with a current and more accurate status for communication and progress within a process, by receiving notification and shared communications received and/or sent from other collaborator users in a process.

Relationship management application 110 may then be used by collaborator users to interact with a relationship management system generated by the relationship management server 120. The relationship management server 120, in embodiments discussed herein, generates reports responsive to requests of the relationship management application 110, provides contact information lists, illustrates various processes associated with a user and the communications between relationships and collaborators within the process, and provides additional intelligence, such as latest communication, time since last communication, who contacted a relationship within a process, which team member should follow up with a relationship, automatic communication sharing, etc.

In one embodiment, electronic communication aggregator 122 periodically queries the different electronic communications systems associated with each of the registered users in order to obtain the most recent electronic communications. In one embodiment, as these communications are obtained, relationship analyzer 124 performs ongoing analysis of those communications, to determine whether and how to share the communications with the collaborators enumerated in one or more communication sharing lists. The shared communications may then be presented to the appropriate collaborator users via the relationship management application 110.

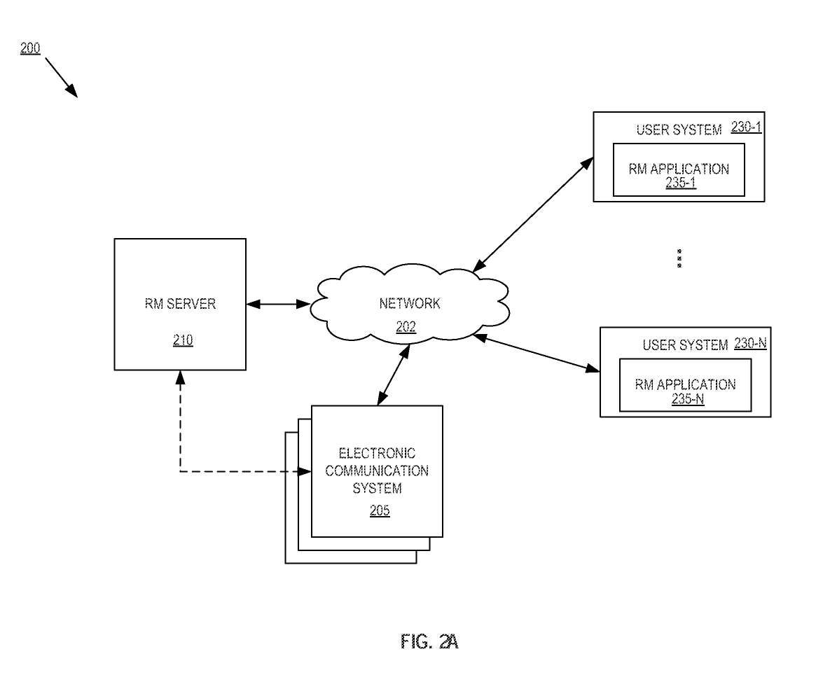

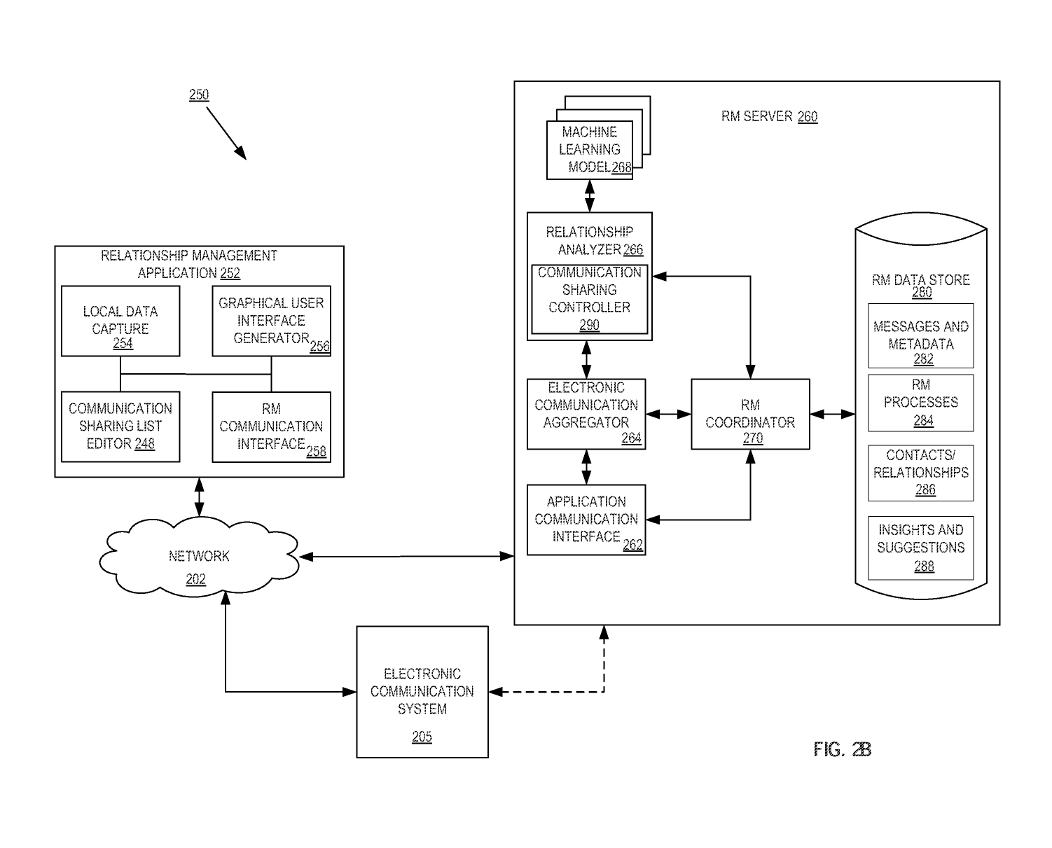

FIG. 2A is a block diagram of exemplary system architecture for providing a relationship management system.

In one embodiment, the system 200 includes a plurality of user systems, such as user system 230-1 to user system 230-N, relationship management server 210, and a plurality of electronic communication systems 205. In one embodiment, user systems 230-1 to user system 230-N may each be a personal computing device, such as a desktop computer, laptop computer, tablet computer, mobile computing device, mobile communication device, etc. The relationship management server 210 and electronic communication system 205 may also be computing devices, such as server computers, desktop computers, etc.

The user systems 230-1 through 230-N, relationship management server 210, and electronic communication system 205 may be coupled to a network 202 and communicate with one another using any of the standard protocols for the exchange of information. In one embodiment, when a user system is a mobile computing device or mobile communication device, the user system may be coupled with network 202 via a wireless connection, such as a cellular telephone connection, wireless fidelity connection, etc.

In one embodiment, one or more of the user systems 230-1 through user system 230-N, relationship management server 210, and the plurality of electronic communication systems 205 may run on one Local Area Network (LAN) and may be incorporated into the same physical or logical system, or different physical or logical systems. Alternatively, the user systems 230-1 through user system 230-N, relationship management server 210, and the plurality of electronic communication systems 205 may reside on different LANs, wide area networks, cellular telephone networks, etc. that may be coupled together via the Internet but separated by firewalls, routers, and/or other network devices. In yet another configuration, the relationship management server 210 and one or more of the electronic communication systems 205 may reside on the same server, or different servers, coupled to other devices via a public network (e.g., the Internet) or a private network (e.g., LAN). It should be noted that various other network configurations can be used including, for example, hosted configurations, distributed configurations, centralized configurations, etc.

In one embodiment, relationship management application 235-1 through relationship management application 235-N may be applications presented to a user via a web interface, stand-alone applications installed on user systems 230-1 through 230-N, a mobile application, or a combination of application types. In one embodiment, relationship management applications 235-1 through 235-N are user applications that enable a user to register with relationship management server 210 for the automatic and intelligent creation of a relationship management system, to interact with a resulting relationship management system, to set up communication sharing lists, specify privacy sharing options, and to exchange and share relevant relationship management communications with communication sharing list members within the relationship management system.

In one embodiment, relationship management server 210 automatically obtains past and future electronic communications to and from the user by utilizing received usernames and access credentials to access the specified electronic communication systems 205. For example, relationship management server 210 may access email systems, such as GMAIL™, EXCHANGE™, etc., social networking systems, such as FACEBOOK™ LINKEDIN™, etc., VOIP systems, teleconferencing systems, etc. Once authenticated into an electronic communication system 205, relationship management server 210 accesses the user's electronic communications.

In one embodiment, relationship management server 210 analyzes each electronic communication, from the plurality of different communication channels, to extract sender and receiver data, as well as other information (e.g., communication content, communication direction, whether communications are a response, etc.). Relationship management server 210 then utilizes the extracted data to determine whether an obtained electronic communication should be shared. In one embodiment, relationship management server 210 determines whether a relationship and a collaborator are involved in the communication (such as communication initiator, communication receiver, a cc′d recipient, meeting invitee, teleconference participant, etc.), and whether the relationship and collaborator belong to a communication sharing list. As is discussed in greater detail herein, the communication sharing list is an enumerated list, created by a collaborator within a process, that identifies other process collaborators and process relationships. Then when communications are exchanged between at least one collaborator and at least one relationship within the communication sharing list, the communication is subject to sharing with the other collaborators enumerated within the communication sharing list. Furthermore, the sharing may be controlled and/or limited by the specification of sharing options of the collaborator who is the primary collaborator associated with the communication. In one embodiment, the collaborator can be identified as the primary collaborator when they are either the collaborator that initiated a communication, or a select collaborator that receives a communication, as discussed in greater detail below.

In one embodiment, relationship management server 210 periodically accesses electronic communication systems 205 to check for new electronic communications. Relationship management server 210 analyzes the new communications individually, using the one or more pre-trained machine learning model analysis techniques, and in view of the corpus of previously analyzed communications. In one embodiment, the analysis may include updating a communications graph associated with the user, determining whether to merge contacts, determining automatic suggestions related to the communications, determining whether to share the communications, etc.

FIG. 2B is a block diagram of one embodiment 250 of a relationship management application 252 and a relationship management server 260. Relationship management application 252 and a relationship management server 260 provide additional details for the relationship management applications and a relationship management server discussed above in FIGS. 1 and 2A.

In one embodiment, relationship management application 252 includes a relationship management communication interface 258, graphical user interface generator 256, local data capture 254, and communication sharing list editor 248. Relationship management server 260 includes an application communication interface 262, electronic communication aggregator 264, relationship analyzer 266, communication sharing controller 290, one or more machine learning models 268, relationship management coordinator, and relationship management data store 280. In one embodiment, the relationship management application 252 and a relationship management server 260 communicate with each other over various networks and network configurations as discussed above in FIG. 2A.

In the relationship management application 252, graphical user interface generator 256 is responsible for generating an interface for a user for accessing the relationship management application. In embodiments discussed herein, the relationship management application 252 may generate the application interface as a web page, a standalone application, or a mobile application, based upon the type of computing system upon which the relationship management application 252 is executed. In one embodiment, relationship management application 252 receives a user request to register with relationship management server 260, and for the creation of a new relationship management system. In one embodiment, the request includes user specification of a username and password to be associated with the relationship management system, as well as login credentials for one or more electronic communication systems 205. In one embodiment, the login credentials are access privileges provided to relationship management server 250 for each electronic communication system 205 obtained utilizing an authentication protocol, such as the OAuth service.

Relationship management communication interface 258 transmits the request, usernames, and authentication credentials to the application communication interface 262 of the relationship management server 260. In one embodiment, relationship management communication interface 258 and application communication interface 262 communicate with one another using standard communications protocols, such as HTTP, HTTPS, etc. Additionally, the data exchanged between relationship management communication interface 258 and application communication interface 262 may be exchanged as a single message, or a series of messages.

Application communication interface 262 provides the request, the user access credentials and the relationship management username/password combination to relationship management coordinator 270. Relationship management coordinator 270 provisions storage space within relationship management data store 280 for the new relationship management system to be created for the user.

Relationship management coordinator 270 further provides the user's authentication credentials for the various electronic communications systems to electronic communications aggregator 264. Electronic communications aggregator 264 utilizes the user's authentication credentials to access the electronic communication systems 205 via network 202 or locally (as indicated by dashed line). Initially, electronic communications aggregator 264 obtains all, or at least a portion, of the user's past communication activities on each of the electronic communication systems 205. These communications are provided to relationship analyzer 266 to apply one or more of machine learning models 268 to analyze the electronic communications. In one embodiment, the machine learning models are pre-trained machine learning methods, such as one or more natural language analysis, support vector machines, conditional random fields, unsupervised learning (e.g., clustering), etc. In one embodiment, relationship analyzer 266 applies the models 268 in order to extract contact information from the user's communication with other users (i.e., names, phone numbers, email addresses, job titles, affiliated companies, web sites, etc.).

Relationship analyzer 266 provides the results from the machine learning model analysis to relationship management coordinator 270 for storage in a contacts/relationships database 286 in relationship management data store 280. In one embodiment, when electronic communication aggregator 264 passes the obtained electronic communications to relationship analyzer 266, the electronic communications are also passes to relationship management coordinator 270 for storage in a database 282 in relationship management data store 280.

In one embodiment, relationship analyzer 266 further determines one or more processes to associate with the user based on the user's communications. As discussed herein, the communications may indicate the user engaging in a sales process with a first group of users, engaging in a recruiting process with a second group of users, etc. The relationship management coordinator 270 stores these determined processes, and the additional user contacts associated with these processes in database 284 and 286. As discussed herein, the users and contacts that are added to a process may be one or more relationships in a process from outside of an organization, or one or more collaborators in a process from within an organization. Although databases 282, 284, 286, and 288 are illustrated as separate databases in data store 280, consistent with the discussion herein, the databases may be combined into a single database or a combination of databases in relationship management data store 280.

In one embodiment, electronic communication aggregator 264 periodically obtains new electronic communications sent to, or from, the user of relationship management application 252 from electronic communication systems 205. In one embodiment, relationship management application 252 supplements the data gathered by electronic communication aggregator 264 by utilizing local data capture 254. In one embodiment, local data capture 254 records communication data, such as telephone call data, video conference data, chat data, etc. that is initiated within relationship management application 252, or that is initiated on a device that is executing relationship management application 252. The electronic communication data gathered by local data capture 254 is transmitted via interfaces 258 and 262 to electronic communication aggregator 264.

As electronic communication aggregator 264 periodically obtains new communications, the new communications are provided to relationship analyzer 266. Relationship analyzer 266 analyzes the new communications with one or more of the pre-trained machine learning models 268. Furthermore, relationship analyzer 266 analyzes the new communications in view of the prior communications stored in relationship management data store 280. In one embodiment, relationship analyzer 266 loads the previously obtained messages from electronic messages and metadata 282.

In one embodiment, processes may be multi-user processes within an organization, such that multiple collaborators within the organization participate in the same process with a common group of relationships outside of the organization. In order to foster a greater degree of knowledge about ongoing relationship management process activities, in one embodiment, communications between a collaborator and relationship within a process may be shared with the other collaborators in the process. In one embodiment, a collaborator may create a communication sharing list at relationship management server 260. In one embodiment, the collaborator accesses a communication sharing list editor 248 at relationship management application 252. The relationship management application 252 thereafter receives the collaborator's enumeration of communication sharing list members (e.g., process collaborators and process relationships), the specification of one or more privacy sharing options for communication sharing, and transfers the list and privacy options to relationship management server 260. Communication sharing controller 290 of relationship management server 260 stores the enumerated list in data store 280 or a data store within communication sharing controller 290 (not shown). Communication sharing controller 290 thereafter informs the enumerated collaborators within the new communication sharing list that they have been added to the list. Once added, communication sharing controller 290 may receive additional privacy sharing options settings from the enumerated collaborators.

In one embodiment, as electronic communication aggregator 264 obtains new communications from electronic communications system 205, the communications are provided to relationship analyzer 266. As discussed herein, relationship analyzer 266 extracts information from the communications to determine communication sender, receiver, etc. In one embodiment, the information may be extracted from message headers, content within the message, as well as other sources. The extracted data is provided to communication sharing controller 290 to determine whether the communication triggers a communication sharing option. In one embodiment, communication sharing controller 290 analyzes the extracted data to determine whether any identified collaborators and relationships involved in the communication belong to the same communication sharing list. For example, an electronic mail message may be exchanged between a collaborator and a relationship that are both members of a communication sharing list. As another example, a meeting invitation may include collaborators and relationships as invitees to the meeting, which are members of the same communication sharing list. As yet another example, a group teleconference may include collaborators and relationships as participants, which are members of the same communication sharing list.

When communication sharing controller 290 determines that an electronic communication is eligible for sharing, communication sharing controller accesses the sharing options of a primary collaborator associated with the communication. In one embodiment, the collaborator is determined to be the primary collaborator of an outgoing electronic communication when they are the communication initiator. Furthermore, the collaborator is determined to be the primary collaborator of an incoming electronic communication when they are one or more of the first named recipient of the communication, the recipient with the most restrictive privacy sharing options, the recipient with the least restrictive privacy sharing options, the recipient with the most authority in an organization, the recipient that generated a communication sharing list, etc. The primary collaborators sharing options are then utilized by communication sharing controller 290 to route communication details and/or communication content to the other collaborators in the relevant communication sharing list(s).

In one embodiment, as discussed in greater detail below, after the communication details and/or content has been shared with collaborators, communication sharing controller 290 may receive one or more requests to alter the sharing privacy options and/or access rights to the shared information. In one embodiment, relationship management application 252 may receive a request from a primary collaborator (i.e., the collaborator who's communication is being shared with other collaborators in a communication sharing list) to alter sharing options with respect to a particular communication. In one embodiment, communication sharing controller 290 receives the request and alters the amount and type of sharing. For example, a collaborator in a communication sharing list may have set a privacy sharing option that allows communication content to be shared with other collaborators in the list. However, the collaborator may determine that due to sensitive information within the communication, the content of the communication should not be shared with other collaborators. In one embodiment, communication sharing controller 290 may receive a request to alter the sharing options for the individual message, such as only sharing the existence of the communication and not the content. This one-time change to the sharing privacy options, however, does not alter the collaborator's set privacy sharing options for other communications.

In one embodiment, relationship management application 252 may also receive a request from a collaborator of a communication sharing list to access more information in a sharing list-eligible communication. For example, a communication between a collaborator and a relationship that are members of a communication sharing list may result in the existing of the communication being shared. Another list collaborator may then identify the communication as one she would like access to the content of the communication. Communication sharing controller 290 would receive the request and notify the primary message collaborator (i.e., collaborator message initiator or first collaborator recipient). The primary collaborator is then able to decide whether to share the communication with the requesting collaborator list member, as well as to determine the amount of information shared. Continuing the example, the primary message collaborator could decide that the requesting collaborator should be made aware of the communication's data and time, but that the content should not be shared, thereby providing the requesting collaborator with additional communication information, but less than all of the requested information from the communication. In one embodiment, the decision of the primary collaborator is received by the communication sharing controller 290, and data associated with the communication is shared based on the options selected by the primary collaborator with respect to the particular communication. Similar to the discussion above, the one-time change to the privacy sharing options do not alter the set sharing options with respect to other communications.

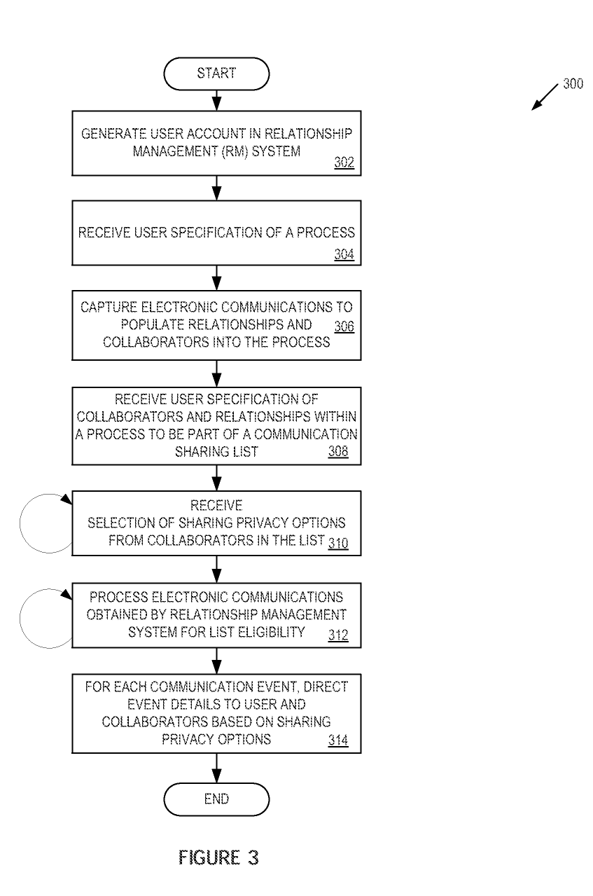

FIG. 3 is a flow diagram of one embodiment of a method 300 for communication sharing in a relationship management system. The method 300 is performed by processing logic that may comprise hardware (circuitry, dedicated logic, etc.), software (such as is run on a general purpose computer system or a dedicated machine), firmware, or a combination. In one embodiment, the method 300 is performed by a relationship management server, such as relationship management server 120, 210, or 260.

Referring to FIG. 3, processing logic begins by generating a user account on a relationship management server (processing block 302). In one embodiment, the user account is generated in response to a user request. In another embodiment, the account is generated for one or more users in response to a request of an administrator. In one embodiment, the account may be a request for a new relationship management system. In another embodiment, the request may be a request for an account to join an existing relationship management system, in which one or more processes are already selected in the existing relationship management system. Processing logic receives user specification of a process (processing block 304) and captures electronic communications to populate relationships and collaborators into the process (processing block 306). In one embodiment, processing blocks 302, 304, and 306 automatically generate and manage a process within a relationship management system as set forth in U.S. patent application Ser. No. 14/050,125, filed Oct. 9, 2013, and entitled “SYSTEMS AND METHODS FOR AUTOMATIC GENERATION OF A RELATIONSHIP MANAGEMENT SYTSEM,” which is incorporated into the present application in its entirety.

Processing logic then receives user specification of one or more collaborators and one or more relationships within a process to be part of a communication sharing list (processing block 308). As discussed above, the communication sharing list can be considered as a type of interest group, or subset of collaborators, within a process. The communications between collaborators enumerated in the communication sharing list and at least one relationship enumerated within the communication sharing list can then be shared with the remaining list collaborators. For example, a sales process may involve several collaborators and several relationships. However, only a select number of collaborators are involved in negotiating a specific issue within the process. This select group of collaborators could then share their communications around the specific issue by establishing a communication sharing list that enumerates the collaborators and relationships that are likely to communicate on that specific issue.

After the collaborators within a communication sharing list have been enumerated, processing logic receives selection of sharing privacy options from collaborators in the list (processing block 310). In one embodiment, the privacy options are received by the collaborators when they accept membership in a communication sharing list. However, the privacy options may be altered by collaborator list members at any time. In one embodiment, if no privacy options are selected by a list collaborator when joining a communication sharing list, processing logic defaults to full communication sharing.

Processing logic then processes electronic communications obtained by the relationship management system for list eligibility (processing block 312). In one embodiment, when a collaborator user joins a list, processing logic obtains past and future electronic communications associated with the collaborator. The communications may be obtained from third party electronic communication systems, as well as past communications stored by a relationship management system. In one embodiment, only a specified number of past communications, or communications occurring within a specific time of a time when a collaborator joined a sharing list, are obtained by processing logic. In one embodiment, for each communication, processing logic determines list eligibility by determining whether the communication is exchanged between at least one list collaborator and at least one list relationship.

For each list eligible communication, processing logic routes details associated with the communication to collaborators based on one or more privacy sharing options (processing block 314). In one embodiment, the privacy sharing options are the options selected by a primary collaborator, where the primary collaborator is determined as discussed above. Furthermore, the details associated with the communication that may be shared include the communication itself, content extracted from the communication, notice of an occurrence of the communication, etc. In one embodiment, processing logic may include additional relationship management data with the shared communication details, such as time of last communication between the sender and recipient, a number of communications exchanged, usual time to respond, an automatic suggestions generated in response to the communication, etc. The relationship management data is selected by processing logic by analyzing a corpus of electronic communications between collaborators and relationships in a process, communications between a specific sender and receiver, as well as other data relevant to a process associated with the communication sharing list.

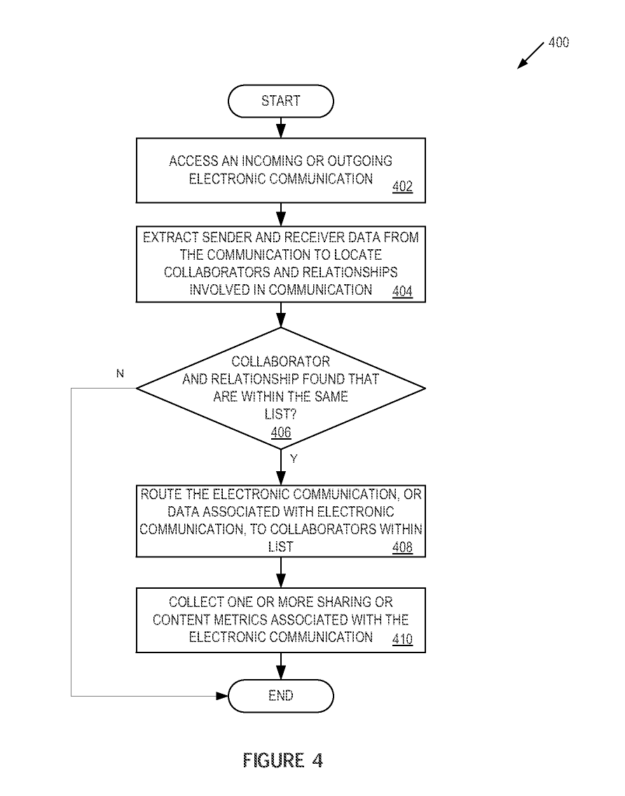

FIG. 4 is a flow diagram of one embodiment of a method 400 for processing electronic communications for communication sharing in a relationship management system. The method 400 is performed by processing logic that may comprise hardware (circuitry, dedicated logic, etc.), software (such as is run on a general purpose computer system or a dedicated machine), firmware, or a combination. In one embodiment, the method 400 is performed by a relationship management server, such as relationship management server 120, 210, or 260.

Referring to FIG. 4, processing logic begins by accessing an incoming or outgoing electronic communication (processing block 402). In one embodiment, the electronic communication may be an electronic mail message, calendar invitation, a telephone call record, etc. As discussed above, processing logic may periodically access different electronic communication systems to access the various incoming and outgoing communications of relationship management system collaborators.

Processing logic extracts sender and receiver data from the communication to locate collaborators and relationships involved in the communication (processing block 404). In one embodiment, processing logic extracts contact data from message addressing fields, such as “from,” “to,” “CC,” “invitee,” etc. fields. Message headers, metadata fields, and content may also be parsed and analyzed in an electronic communication or electronic communication record for the existence of additional information, such as message sender and recipient identification information in the message headers and/or metadata fields, message sender and recipient identification information extracted from the message content, location information, electronic meeting start and end times, electronic meeting content, telephone call duration, telephone call status as incoming, outgoing, accepted, or missed, etc.

From the extracted data, processing logic determines whether a message has been exchanged and includes at least one collaborator and at least one relationship that are enumerated in the same communication sharing list (processing block 406). In one embodiment, an electronic message, meeting, telephone call, teleconference, etc. that includes at least one relationship and at least one collaborator that are each enumerated in a sharing list, the message, meeting, call, etc. is subject to potential sharing as discussed herein. For example, an electronic email message sent from a third part to a relationship and collaborator on a list would be subject to potential communication sharing. Similarly, a scheduled meeting that included several collaborators and a relationship from a list would also be subject to potential communication sharing. When an electronic communication is exchanged that does not include at least one relationship and at least one collaborator that are list members, the process ends and the communication details are not shared. However, when the electronic communication is exchanged between list members (i.e., at least one list collaborator and at least one list relationship), the process advances to processing block 408.

Processing logic then routes the electronic communication, or data associated with the electronic communication, to the other collaborators within the communication sharing list (processing block 408). As discussed herein, the amount of information from a communication that is shared is subject to sharing privacy options. When the communication data is routed to other collaborators, processing logic collects one or more sharing and/or content metrics associated with the electronic communication (processing block 410). In one embodiment, the metrics include communication intelligence data, such as time since last communication, who initiated the last communication, a number of total communications exchanged between with a relationship, a type of last communication, direction of last communication, as well as other metrics. Furthermore, the metrics for communications authorized by one or more privacy settings in a communication sharing list can be collected and displayed to a user. For example, in response to a user request to see a total number of communication events exchanged between list collaborators with a particular list relationship, processing logic would present the total number of communication events that qualify under the communication sharing options. Other events, such as those which a user/collaborator has not shared with list members will not be utilized for metrics calculation by processing logic.

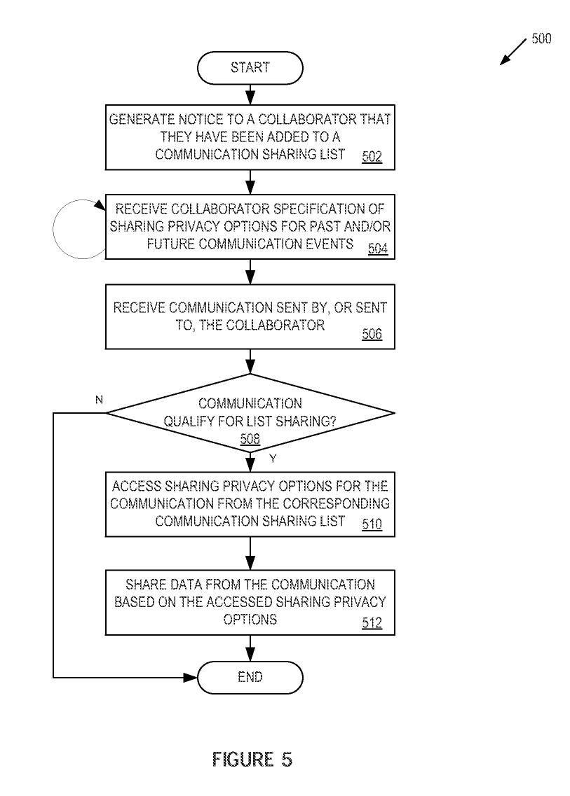

FIG. 5 is a flow diagram of one embodiment of a method 500 for utilizing privacy settings for communication sharing in a relationship management system. The method 500 is performed by processing logic that may comprise hardware (circuitry, dedicated logic, etc.), software (such as is run on a general purpose computer system or a dedicated machine), firmware, or a combination. In one embodiment, the method 500 is performed by a relationship management server, such as relationship management server 120, 210, or 260.

Referring to FIG. 5, processing logic begins by generating notice to a collaborator that they have been added to a communication sharing list (processing block 502). As discussed above, the collaborator is a participant in an ongoing process, who has been selected for inclusion, by another collaborator in the process, to be part of a subset of process collaborators. The communications of exchanged by and between this subset of process collaborators may then be shared with one another, subject to the constraints discussed herein.

After the notification, processing logic receives the specification of one or more sharing privacy options for past and/or future communication events (processing block 504). In one embodiment, the sharing privacy options enable a collaborator to define how much information, if any, from list-eligible communications are shared with other list collaborators. In one embodiment, the sharing privacy options include an option to share nothing, share occurrence of the event but not the content, or share the entire content of an electronic communication. However, other sharing options may be utilized as discussed herein. In one embodiment, the selected sharing privacy options are applied to past communications, as well as present and future communications.

Processing logic then receives a communication sent by, or sent to, the collaborator (processing block 506). In one embodiment, a relationship management system may obtain the collaborator's communications as discussed herein. Processing logic then determines whether the communication qualifies for list sharing (processing block 508). In one embodiment, the communication qualifies for communication privacy list sharing when at least one collaborator and at least one relationship are identified in the communication and enumerated in the communication privacy list. For example, a collaborator and a relationship within a sharing list may both be cc′d on a message sent from a non-list collaborator. As another example, a collaborator and a relationship within a sharing list may both be invited to the same meeting or teleconference. As yet another example, a collaborator and a relationship within a sharing list may exchange a direct telephone communication.

When the communication does not qualify for communication privacy list sharing, the process ends as no communication data is distributed to other list collaborators. However, when the communication is eligible for sharing with collaborators in a communication privacy list, processing logic accesses the collaborator's sharing privacy options from the corresponding communication sharing list (processing block 510). In one embodiment, the same collaborator may be included in many different privacy sharing lists. Furthermore, the collaborator may specify different sharing privacy options for each list membership. Thus, processing logic determines the appropriate sharing privacy options for the appropriate list. Processing logic then shares the data from the communication as specified in the accessed sharing privacy options (processing block 512).

As discussed herein, a collaborator may select sharing privacy options from a spectrum of sharing options, which range from sharing nothing to sharing an entire communication. These options are applied to all messages associated with the collaborator, which are eligible for sharing with other collaborators in a communications privacy list. However, there may be circumstances where pre-selected privacy sharing options are not the optimal sharing options, such as when sensitive content in a message would be inappropriate to share, and conversely when message content is important but unshared. Therefore, the sharing privacy options for a specific communication can be altered without impacting other communications associated with a collaborator and communications privacy list.

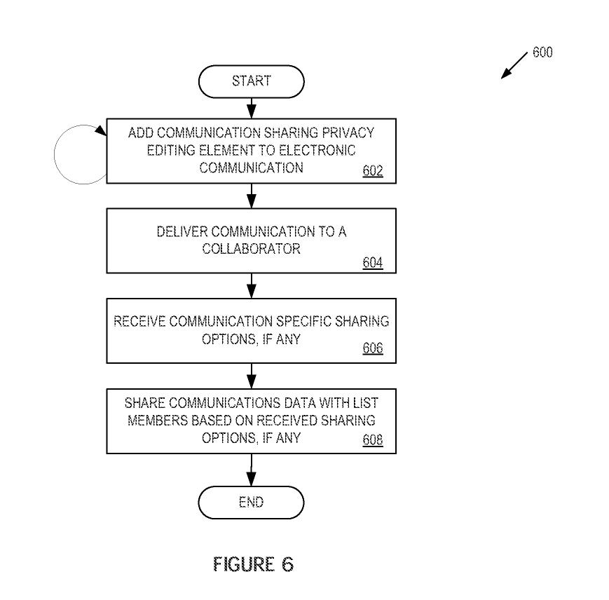

FIG. 6 is a flow diagram of one embodiment of a method for altering the privacy settings for an electronic communication. The method 600 is performed by processing logic that may comprise hardware (circuitry, dedicated logic, etc.), software (such as is run on a general purpose computer system or a dedicated machine), firmware, or a combination. In one embodiment, the method 600 is performed by a relationship management server, such as relationship management server 120, 210, or 260.

Referring to FIG. 6, processing logic begins by adding a communication privacy editing element to an electronic communication (processing block 602). In one embodiment, processing logic adds a user-selectable button or icon that, when selected, enables a user to alter the sharing privacy options for an individual communication. In one embodiment, the button or icon may also be added to a communication viewer application, and not the message itself. Processing logic then delivers the electronic communication to a collaborator (processing block 604).

Processing logic receives communication-specific sharing options, if any (processing block 606). In one embodiment, the communication-specific sharing options alter a set of sharing options pre-selected by the collaborator. The communication is then shared with collaborator list members according to the received communication-specific sharing options (processing block 608). In one embodiment, the communication-specific sharing options are only applied to the specific communication, and do not alter the collaborator's selected sharing options for future or past communications.

Similar to the circumstances where a collaborator associated with a specific communication decides to alter sharing options for the specific communication, a collaborator with whom a message was shared can request additional information from a shared communication. For example, a collaborator enumerated in a list may be aware that a meeting invitation in a sales process was sent, but due to sharing privacy options, is denied access to the content of the message. In one embodiment, the collaborator can request access to communication data associated with a different level of privacy.

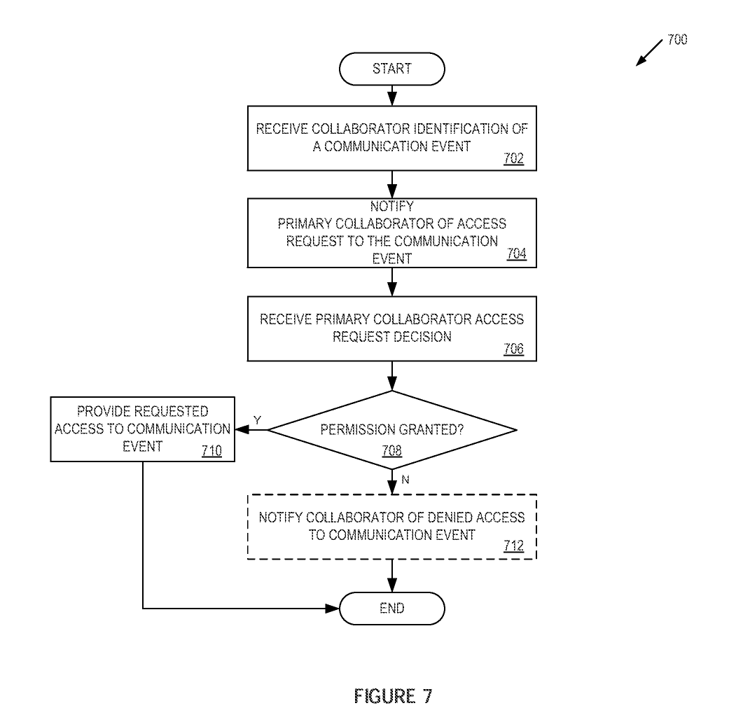

FIG. 7 is a flow diagram of one embodiment of a method 700 for accessing additional information in electronic communications. The method 700 is performed by processing logic that may comprise hardware (circuitry, dedicated logic, etc.), software (such as is run on a general purpose computer system or a dedicated machine), firmware, or a combination. In one embodiment, the method 700 is performed by a relationship management server, such as relationship management server 120, 210, or 260.

Referring to FIG. 7, processing logic begins by receiving identification by a collaborator of a communication event (processing block 702). In one embodiment, the collaborator is enumerated in a communication sharing list, and the communication event is a list-eligible communication. In response to receiving the identification from the collaborator, processing logic notifies a primary collaborator of the access request to the communication event (processing block 704). In one embodiment, as discussed above, the primary collaborator is the initiator of the communication event, the first listed recipient of the communication event, the collaborator with the least restrictive sharing options, etc. In one embodiment, the notification may include the requested amount or level of access to the communication event. Although some information from a communication event may already be shared, the collaborator may request further communication details. Similarly, requests may be made to access previously unshared communications.

Processing logic receives the primary collaborator's decision as to the requested access to the communication (processing block 706). When the primary collaborator grants permission (processing block 708), the requesting collaborator is provided the requested access to the communication event (processing block 710). However, when the primary collaborator denies permission (processing block 708), a notification may be generated to the requesting collaborator to inform the requesting collaborator of the denied access (processing block 712). In one embodiment, the notification to a collaborator that their request for access has been denied is optional, as indicated by dashed line, and the user is not given the request information and/or level of access.

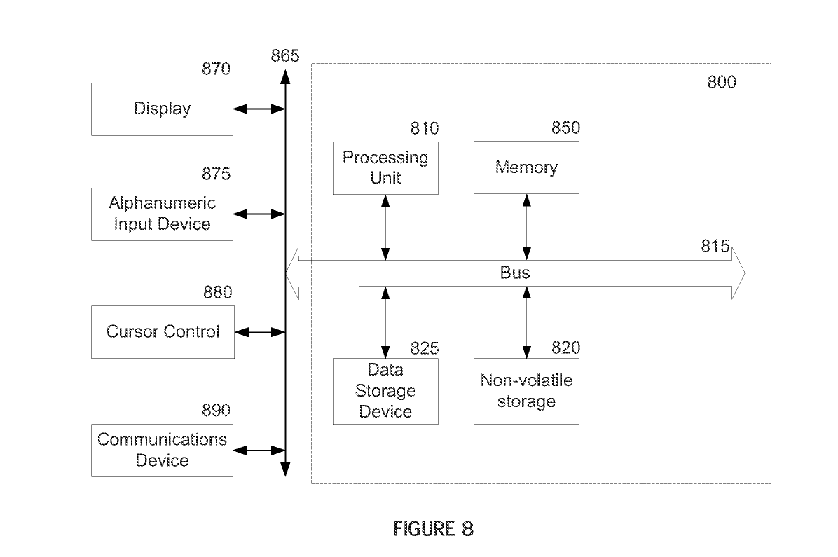

FIG. 8 is one embodiment of a computer system that may be used with the present invention. It will be apparent to those of ordinary skill in the art, however that other alternative systems of various system architectures may also be used.

The data processing system illustrated in FIG. 8 includes a bus or other internal communication means 815 for communicating information, and a processor 810 coupled to the bus 815 for processing information. The system further comprises a random access memory (RAM) or other volatile storage device 850 (referred to as memory), coupled to bus 815 for storing information and instructions to be executed by processor 810. Main memory 850 also may be used for storing temporary variables or other intermediate information during execution of instructions by processor 810. The system also comprises a read only memory (ROM) and/or static storage device 820 coupled to bus 815 for storing static information and instructions for processor 810, and a data storage device 825 such as a magnetic disk or optical disk and its corresponding disk drive. Data storage device 825 is coupled to bus 815 for storing information and instructions.

The system may further be coupled to a display device 870, such as a cathode ray tube (CRT) or a liquid crystal display (LCD) coupled to bus 815 through bus 865 for displaying information to a computer user. An alphanumeric input device 875, including alphanumeric and other keys, may also be coupled to bus 815 through bus 865 for communicating information and command selections to processor 810. An additional user input device is cursor control device 880, such as a touchpad, mouse, a trackball, stylus, or cursor direction keys coupled to bus 815 through bus 865 for communicating direction information and command selections to processor 810, and for controlling cursor movement on display device 870.

Another device, which may optionally be coupled to computer system 800, is a communication device 890 for accessing other nodes of a distributed system via a network. The communication device 890 may include any of a number of commercially available networking peripheral devices such as those used for coupling to an Ethernet, token ring, Internet, or wide area network. The communication device 890 may further be a null-modem connection, or any other mechanism that provides connectivity between the computer system 800 and the outside world. Note that any or all of the components of this system illustrated in FIG. 8 and associated hardware may be used in various embodiments of the present invention.

It will be appreciated by those of ordinary skill in the art that any configuration of the system may be used for various purposes according to the particular implementation. The control logic or software implementing the present invention can be stored in main memory 850, mass storage device 825, or other storage medium locally or remotely accessible to processor 810.

It will be apparent to those of ordinary skill in the art that the system, method, and process described herein can be implemented as software stored in main memory 850 or read only memory 820 and executed by processor 810. This control logic or software may also be resident on an article of manufacture comprising a computer readable medium having computer readable program code embodied therein and being readable by the mass storage device 825 and for causing the processor 810 to operate in accordance with the methods and teachings herein.

The present invention may also be embodied in a handheld or portable device containing a subset of the computer hardware components described above. For example, the handheld device may be configured to contain only the bus 815, the processor 810, and memory 850 and/or 825. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

The present invention may also be embodied in a special purpose appliance including a subset of the computer hardware components described above. For example, the appliance may include a processor 810, a data storage device 825, a bus 815, and memory 850, and only rudimentary communications mechanisms, such as a small touch-screen that permits the user to communicate in a basic manner with the device. In general, the more special-purpose the device is, the fewer of the elements need be present for the device to function.

In one embodiment, the access to electronic communications, tracking of communications, extraction of contact, collaborator, and relationship data from the electronic communications, and sharing of electronic communications is predicated on the privacy controls maintained by a relationship management server. The privacy controls enable users to select what data should be shared with participants (i.e., relationships and collaborators) within a process, what data should be tracked, what data from one user can be shared, displayed, or used by a second user, etc. In one embodiment, these privacy controls may initially be set to a maximum degree of privacy, such that no data is shared, obtained, or tracked. A user may then opt-into one or more of the data acquisition, tracking, and sharing processes discussed herein.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

We claim:

1. A computer-implemented method, comprising:
obtaining an electronic communication by a relationship management system;
extracting identification data from the electronic communication;
locating a collaborator and a relationship in the extracted identification data, wherein the collaborator and the relationship are participants in a relationship management process, and wherein the relationship management process is a combination of one or more collaborators within an organization, one or more relationships outside of the organization, and a sequential series of stages of communication between the one or more collaborators and the one or more relationships;
determining when the collaborator and the relationship are both members in a communications sharing list that is associated with the relationship management process; and
distributing data associated with the electronic communication to collaborator members in the communications sharing list.

2. The method of claim 1, wherein the communications sharing list enumerates a subset of the collaborators and a subset of the relationships in the relationship management process, wherein the identification data extracted from the electronic communication includes at least one of the collaborators in the subset of collaborators and at least one of the relationships in the subset of relationships are distributed to the remaining collaborators in the subset of collaborators.

3. The method of claim 2, further comprising:
determining that the electronic communication is eligible for sharing with the subset of the collaborators in the communications sharing list when either the collaborator initiated the electronic communication and the relationship is a recipient of the electronic communication, or the relationship initiated the electronic communication and the collaborator is a recipient of the electronic communication, wherein the electronic communication is an electronic mail message; and
distributing the data associated with the electronic communication in response to determining that the electronic communication is eligible for sharing and the collaborator and the relationship are enumerated in the same communications sharing list.

4. The method of 2, further comprising:
determining that the electronic communication is eligible for sharing with the subset of the collaborators in the communications sharing list when both the collaborator and the relationship are identified as participants in a telephone call; and
distributing the data associated with the electronic communication in response to determining that the electronic communication is eligible for sharing and the collaborator and the relationship are enumerated in the same communications sharing list.

5. The method of 2, further comprising:
determining that the electronic communication is eligible for sharing with the subset of the collaborators in the communications sharing list when both the collaborator and the relationship are identified within an electronic meeting invitation; and
distributing the data associated with the electronic communication in response to determining that the electronic communication is eligible for sharing and the collaborator and the relationship are enumerated in the same communications sharing list.

6. The method of claim 1, wherein distributing data associated with the electronic communication to collaborator members in the communications sharing list, further comprises:
determining one or more privacy sharing options associated with the collaborator for the communications sharing list, wherein the privacy sharing options are a set of options selected by the collaborator that determine what data from an electronic communication is to be shared with the collaborator members in the communications sharing list for electronic communications sent or received by the collaborator;
extracting the data from with the electronic communication based on the one or more privacy sharing options; and
distributing the extracted data associated with the electronic communication to collaborator members in the communications sharing list.

7. The method of claim 6, wherein the collaborator associated with the determined one or more privacy sharing options is one of a plurality of collaborators enumerated in the communications sharing list, and wherein the collaborator is associated with a least restrictive set of communications sharing options compared to sharing options associated with the remaining plurality of collaborators.

8. The method of claim 6, further comprising:
receiving a request from one of the collaborator members in the communications sharing list for additional data associated with the electronic communication;
notifying the collaborator of the request;
receiving a response from the collaborator that specifies an alteration to the one or more privacy sharing options associated with the collaborator for the communications sharing list;
extracting a different data from with the electronic communication based on the altered one or more privacy sharing options; and
distributing the different data to the requesting one of the collaborator members.

9. The method of claim 8, wherein the alteration to the one or more privacy sharing options is applied only to the electronic communication associated with the received request.

10. The method of claim 6, further comprising:
receiving a notification from the collaborator to alter the one or more privacy sharing options associated with the electronic communication; and
extracting different data from with the electronic communication based on the altered one or more privacy sharing options; and
distributing the different data to collaborator members in the communications sharing list.

11. The method of claim 10, wherein the alteration to the one or more privacy sharing options is applied only to the electronic communication associated with the received notification.

12. The method of claim 6, wherein the one or more privacy sharing options comprise one or more of an option to share nothing from electronic communications, an option to share the existence of an electronic communication but not the electronic communication's content, and an option to share the content of the electronic communication.

13. The method of claim 1, further comprising:
collecting one or more relationship management system metrics associated with the distributed data from the electronic communication; and
presenting a relationship management system metric in response to a collaborator request, wherein the collaborator is enumerated within the communication sharing list, and wherein the relationship management system metric is compiled with data collected from electronic communications that satisfy one or more privacy sharing options defined by collaborator list members.

14. A non-transitory computer readable storage medium including instructions that, when executed by a processor, cause the processor to perform a method comprising:
obtaining an electronic communication by a relationship management system;
extracting identification data from the electronic communication;
locating a collaborator and a relationship in the extracted identification data, wherein the collaborator and the relationship are participants in a relationship management process, and wherein the relationship management process is a combination of one or more collaborators within an organization, one or more relationships outside of the organization, and a sequential series of stages of communication between the one or more collaborators and the one or more relationships;
determining when the collaborator and the relationship are both members in a communications sharing list that is associated with the relationship management process; and
distributing data associated with the electronic communication to collaborator members in the communications sharing list.

15. The non-transitory computer readable storage medium of claim 14, wherein the communications sharing list enumerates a subset of the collaborators and a subset of the relationships in the relationship management process, wherein the identification data extracted from the electronic communication includes at least one of the collaborators in the subset of collaborators and at least one of the relationships in the subset of relationships are distributed to the remaining collaborators in the subset of collaborators.

16. The non-transitory computer readable storage medium of claim 15, further comprising:
determining that the electronic communication is eligible for sharing with the subset of the collaborators in the communications sharing list when either the collaborator initiated the electronic communication and the relationship is a recipient of the electronic communication, or the relationship initiated the electronic communication and the collaborator is a recipient of the electronic communication, wherein the electronic communication is an electronic mail message; and
distributing the data associated with the electronic communication in response to determining that the electronic communication is eligible for sharing and the collaborator and the relationship are enumerated in the same communications sharing list.

17. The non-transitory computer readable storage medium of 15, further comprising:
determining that the electronic communication is eligible for sharing with the subset of the collaborators in the communications sharing list when both the collaborator and the relationship are identified as participants in a telephone call; and
distributing the data associated with the electronic communication in response to determining that the electronic communication is eligible for sharing and the collaborator and the relationship are enumerated in the same communications sharing list.

18. The non-transitory computer readable storage medium of 15, further comprising:
determining that the electronic communication is eligible for sharing with the subset of the collaborators in the communications sharing list when both the collaborator and the relationship are identified within a meeting invitation; and
distributing the data associated with the electronic communication in response to determining that the electronic communication is eligible for sharing and the collaborator and the relationship are enumerated in the same communications sharing list.

19. The non-transitory computer readable storage medium of claim 14, wherein distributing data associated with the electronic communication to collaborator members in the communications sharing list, further comprises:
determining one or more privacy sharing options associated with the collaborator for the communications sharing list, wherein the privacy sharing options are a set of options selected by the collaborator that determine what data from an electronic communication is to be shared with the collaborator members in the communications sharing list for electronic communications sent or received by the collaborator;
extracting the data from with the electronic communication based on the one or more privacy sharing options; and
distributing the extracted data associated with the electronic communication to collaborator members in the communications sharing list.

20. The non-transitory computer readable storage medium of claim 19, wherein the collaborator associated with the determined one or more privacy sharing options is one of a plurality of collaborators enumerated in the communications sharing list, and wherein the collaborator is associated with a least restrictive set of communications sharing options compared to sharing options associated with the remaining plurality of collaborators.

21. The non-transitory computer readable storage medium of claim 19, further comprising:
receiving a request from one of the collaborator members in the communications sharing list for additional data associated with the electronic communication;
notifying the collaborator of the request;
receiving a response from the collaborator that specifies an alteration to the one or more privacy sharing options associated with the collaborator for the communications sharing list;
extracting a different data from with the electronic communication based on the altered one or more privacy sharing options; and
distributing the different data to the requesting one of the collaborator members.

22. The non-transitory computer readable storage medium of claim 21, wherein the alteration to the one or more privacy sharing options is applied only to the electronic communication associated with the received request.

23. The non-transitory computer readable storage medium of claim 19, further comprising:
receiving a notification from the collaborator to alter the one or more privacy sharing options associated with the electronic communication; and
extracting different data from with the electronic communication based on the altered one or more privacy sharing options; and
distributing the different data to collaborator members in the communications sharing list.

24. The non-transitory computer readable storage medium of claim 23, wherein the alteration to the one or more privacy sharing options is applied only to the electronic communication associated with the received notification.

25. The non-transitory computer readable storage medium of claim 19, wherein the one or more privacy sharing options comprise one or more of an option to share nothing from electronic communications, an option to share the existence of an electronic communication but not the electronic communication's content, and an option to share the content of the electronic communication.

26. The non-transitory computer readable storage medium of claim 14, further comprising:
collecting one or more relationship management system metrics associated with the distributed data from the electronic communication; and
presenting a relationship management system metric in response to a collaborator request, wherein the collaborator is within the communication sharing list, and wherein the relationship management system metric is compiled with data collected from electronic communications that satisfy one or more privacy sharing options defined by collaborator list members.

27. A system, comprising:
a memory; and
a processor coupled with the memory to
obtain an electronic communication by a relationship management system,
extract identification data from the electronic communication,
locate a collaborator and a relationship in the extracted identification data, wherein the collaborator and the relationship are participants in a relationship management process, and wherein the relationship management process is a combination of one or more collaborators within an organization, one or more relationships outside of the organization, and a sequential series of stages of communication between the one or more collaborators and the one or more relationships,
determine when the collaborator and the relationship are both members in a communications sharing list that is associated with the relationship management process, and
distribute data associated with the electronic communication to collaborator members in the communications sharing list.

28. The system of claim 27, wherein the communications sharing list enumerates a subset of the collaborators and a subset of the relationships in the relationship management process, wherein the identification data extracted from the electronic communication includes at least one of the collaborators in the subset of collaborators and at least one of the relationships in the subset of relationships are distributed to the remaining collaborators in the subset of collaborators.

29. The system of claim 27, wherein the distribution of data associated with the electronic communication to collaborator members in the communications sharing list, further comprises the processor configured to determine one or more privacy sharing options associated with the collaborator for the communications sharing list, wherein the privacy sharing options are a set of options selected by the collaborator that determine what data from an electronic communication is to be shared with the collaborator members in the communications sharing list for electronic communications sent or received by the collaborator,
extract the data from with the electronic communication based on the one or more privacy sharing options, and
distribute the extracted data associated with the electronic communication to collaborator members in the communications sharing list.

30. The system of claim 29, further comprising the processor configured to
receive a request from one of the collaborator members in the communications sharing list for additional data associated with the electronic communication,
notify the collaborator of the request,
receive a response from the collaborator that specifies an alteration to the one or more privacy sharing options associated with the collaborator for the communications sharing list,
extract a different data from with the electronic communication based on the altered one or more privacy sharing options, and
distribute the different data to the requesting one of the collaborator members.

31. The system of claim 29, further comprising the processor configured to
receive a notification from the collaborator to alter the one or more privacy sharing options associated with the electronic communication, and
extract different data from with the electronic communication based on the altered one or more privacy sharing options, and
distribute the different data to collaborator members in the communications sharing list.
